(19) United States
(12) Patent Application Publication
(10) Pub. No.: US 2022/0047897 A1
(43) Pub. Date: Feb. 17, 2022

(54) Facemask Fan System

(71) Applicant: Claudia Miscinski, Evanston, IL (US)

(72) Inventor: Claudia Miscinski, Evanston, IL (US)

(21) Appl. No.: 17/399,567

(22) Filed: Aug. 11, 2021

Related U.S. Application Data
(60) Provisional application No. 63/065,439, filed on Aug. 13, 2020.

(51) Int. Cl. A62B 18/00; A41D 13/11; A62B 18/02; A62B 23/02

(52) U.S. Cl. CPC A62B 18/006; A62B 23/025; A62B 18/025; A41D 13/1161

(57) ABSTRACT

A facemask fan system is provided. The system includes a facemask comprising a flexible cover having a pair of ear loops disposed on opposing lateral sides of the flexible cover. A fan housing is removably securable to an interior surface of the flexible cover. In some embodiments, the fan housing is integral with the flexible cover, such that the fan housing extends through the flexible cover placing an interior portion of the fan housing on an interior side of the flexible cover and an exterior portion of the fan housing on an exterior side of the flexible cover. A fan is operably connected to a motor and a power source, wherein the fan, motor, and power source are disposed within the fan housing. A plurality of controls is operably connected to the motor, wherein the plurality of controls selectively toggles the motor between an activated state and a deactivated state.

### CROSS REFERENCE TO RELATED APPLICATIONS

This application claims the benefit of U.S. Provisional Application No. 63/065,439 filed on Aug. 13, 2020. The above identified patent application is herein incorporated by reference in its entirety to provide continuity of disclosure.

### BACKGROUND OF THE INVENTION

The present invention relates to facemasks. More particularly, the present invention pertains to a facemask system having a fan to improve air circulation around the user's mouth.

Many individuals wear facemasks to protect themselves from contagions or during the standard course of their workday. Wearing a personal protective facemask can result in feelings of discomfort as exhaled air is trapped behind the mask. These feelings can be further exacerbated in hot climates. As the exhaled air is trapped against the user's face, the user may experience increases in body temperature, sweating, and psychosomatic feelings of difficulty breathing. Furthermore, as facemasks are often worn for extended lengths of time, the buildup of sweat on the face may lead to skin conditions, such as acne. Removing the facemask to expose the user's face to fresh air can be unsafe, exposing the user to potential contagions. This is particularly true in crowded indoor areas, such as many offices, supermarkets, or other frequented public spaces. Therefore, a facemask that can increase air circulation behind the mask to evacuate exhaled air is desired.

In light of the devices disclosed in the known art, it is submitted that the present invention substantially diverges in design elements from the known art and consequently it is clear that there is a need in the art for an improvement to existing facemasks. In this regard, the instant invention substantially fulfills these needs.

### SUMMARY OF THE INVENTION

In view of the foregoing disadvantages inherent in the known types of facemasks now present in the known art, the present invention provides a facemask wherein the same can be utilized for providing convenience for the user when increasing air circulation behind the mask to reduce user discomfort.

The present system comprises a facemask comprising a flexible cover having a pair of ear loops disposed on opposing lateral sides of the flexible cover. A fan housing removably securable to an interior surface of the flexible cover. In some embodiments, the fan housing is integral with the flexible cover, wherein the fan housing extends through the flexible cover such that an interior portion of the fan housing is disposed on an interior side of the flexible cover, and an exterior portion of the fan housing is disposed on an exterior side of the flexible cover. A fan is operably connected to a motor and a power source, wherein the fan, motor, and power source are disposed within the fan housing. A plurality of controls is operably connected to the motor, wherein the plurality of controls selectively toggles the motor between an activated state and a deactivated state.

In some embodiments, a rear surface of the fan housing includes a fastener thereon, wherein the fastener is removably securable to a complementary fastener disposed on an interior surface of the flexible cover. In another embodiment, a front surface of the fan housing includes a mesh guard thereacross. In other embodiments, the pair of ear loops are adjustable in diameter. In yet another embodiment, the pair of ear loops comprise an elastic material. In some embodiments, a drawstring toggle is slidably disposed over each ear loop of the pair of ear loops, wherein the drawstring toggle engages each ear loop at a desired diameter. In another embodiment, a control housing is in operably communication with the fan housing, wherein the plurality of controls is disposed within the control housing. In other embodiments, the control housing further comprises a control fastener disposed on a rear surface thereof, wherein the control fastener is removably securable to a complementary fastener disposed on an exterior surface of the flexible cover. In yet another embodiment, the fan housing further comprises a recharging port operably connected to the power source. In some embodiments, a spacer mask is removably securable to the interior surface of the flexible cover, wherein the fan housing is removably securable to an interior surface of the spacer mask. In another embodiment, the spacer mask comprises a semi-rigid material configured to maintain the facemask at a desired distance from a face of a user. In other embodiments, the flexible cover comprises a plurality of layers, wherein a central layer of the plurality of layers comprises a filter.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1A shows a front perspective view of an embodiment of the facemask fan system.

FIG. 1B shows a rear perspective view of an embodiment of the facemask fan system.

FIG. 2 shows an exploded view of an alternate embodiment of the facemask fan system.

FIG. 3 shows a close-up view of an ear loop of an embodiment of the facemask fan system.

FIG. 4 shows a schematic view of an embodiment of the facemask fan system.

### DETAILED DESCRIPTION OF THE INVENTION

Reference is made herein to the attached drawings. Like reference numerals are used throughout the drawings to depict like or similar elements of the facemask fan system. The figures are intended for representative purposes only and should not be considered to be limiting in any respect.

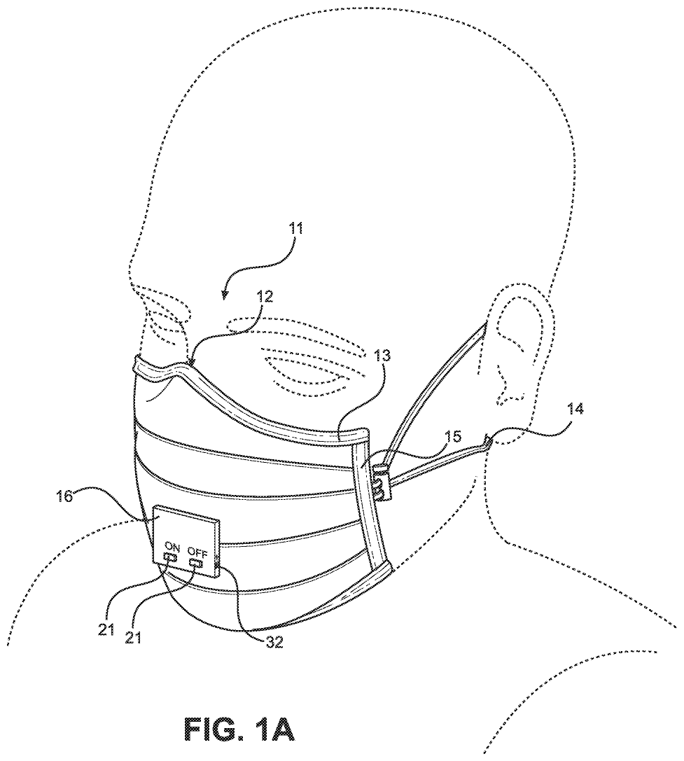

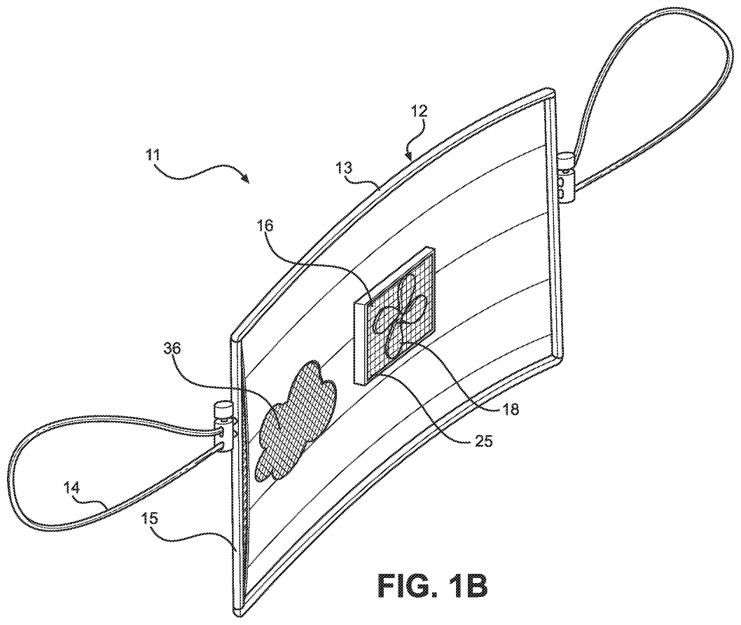

Referring now to FIGS. 1A and 1B, there is shown a front perspective view of an embodiment of the facemask fan system and a rear perspective view of an embodiment of the facemask fan system, respectively. The facemask fan system 11 comprises a facemask 12 having a flexible cover 13 and a pair of ear loops 14 affixed to opposing lateral sides 15 of the flexible cover 13. The flexible cover 13 is contemplated to comprise a variety of traditional facemask materials sufficient to correspond to the various facemask classes, such as N95, N99, N100, R95, P95, P99, and P100. In the shown embodiment of FIG. 1B, the flexible cover 13 comprises a plurality of layers having a pair of fabric layers disposed about an interior central layer 36 comprising a filter corresponding to the desired facemask class. In this manner, the facemask fan system 11 can be utilized with a variety of facemask classifications as desired for the particular need. Similarly, the illustrated embodiments show a traditional surgical facemask, however alternate facemask styles, such as cloth facemasks, are also contemplated facemask 12 form factors.

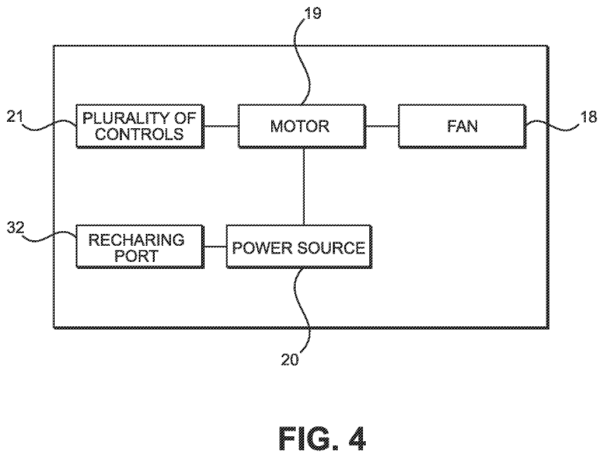

In the illustrated embodiments, a fan housing 16 is integrally disposed through the flexible cover 13. In some such embodiments, the fan housing 16 can be sewn into an existing facemask, or alternatively, manufactured integral with the flexible cover 13. The fan housing 16 is integrally secured through the facemask 12 such that an airtight seal is formed about a perimeter of the fan housing 16 with the flexible cover 13, such that the filtration capabilities of the facemask 12 are maintained. As such, the fan housing 16 extends through the facemask 12, such that an interior portion of the fan housing 16 is disposed on an interior side of the flexible cover 13, whereas an exterior portion of the fan housing 16 is disposed on an exterior side of the flexible cover 13. A fan 18 is disposed within the fan housing 16 and is operably connected to each of a power source (as shown in FIG. 4, 20) and a motor (as shown in FIG. 4, 19), such that when actuated, the fan 18 rotates to circulate air on an interior side of the facemask 12. In this manner, the user's exhaled air is forced from the interior side of the facemask 12 to minimize the user's inhalation of stale air. In the illustrated embodiment, a front surface of the fan housing 16 comprises a mesh guard 25 thereacross, wherein each opening through the mesh guard 25 is dimensioned to prevent the user from contacting the fan 18 while ensuring proper air circulation from the fan 18. Due to the proximity of the fan housing 16 with the user's mouth, for example, the mesh guard 25 serves to prevent the user's tongue, lips, or the like from contacting the fan 18 during use, thereby minimizing the risk of injury.

In the illustrated embodiment of FIG. 1A, a plurality of controls 21 are disposed on an exterior portion of the fan housing 16, wherein the plurality of controls 21 selectively actuate the motor between an activated state and a deactivated state. In some embodiments, the plurality of controls 21 are disposed on the interior portion of the fan housing 16, however, the presence of the plurality of controls 21 on the exterior portion provides access to the plurality of controls 21 without partially removing the facemask 12, thereby ensuring safety of the user during use. Additionally, in the shown embodiment of FIG. 1A, a recharging port 32 is disposed on the fan housing 16, wherein the recharging port 32 is operably connected to the power source. The recharging port 32 is configured to receive a cable therein to transfer energy to the power source and is further contemplated to comprise a variety of formats, such as, but not limited to, a USB port. In this manner, the user can readily recharge the power source between uses to ensure maximum lifetime of the power source. Additionally, in the shown embodiment, the recharging port 32 is disposed on the exterior portion of the fan housing 16 to increase user access while the facemask 12 is in use.

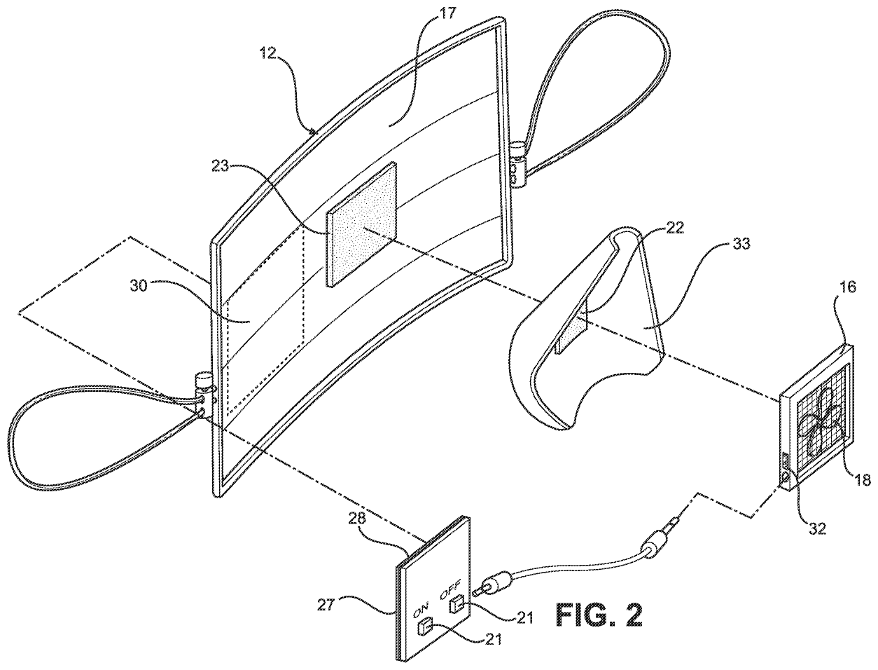

Referring now to FIG. 2, there is shown an exploded view of an alternate embodiment of the facemask fan system. In the illustrated embodiment, the fan housing 16 is removably securable to the facemask 12. As shown, the fan housing 16 includes a fastener 22 thereon, wherein the fastener 22 is removably securable to a complementary fastener 23 disposed on an interior surface 17 of the flexible cover. In some embodiments, the fastener 22 and complementary fastener 23 comprise hook and loop fasteners. In this manner, the user can readily secure the fan housing 16 to an existing facemask 12 via utilization of hook and loop fasteners removably securable to each of the fan housing 16 and the interior surface 17 of the facemask 12. In the illustrated embodiment, a separate control housing 27 is removably securable to the facemask 12, wherein the control housing 27 comprises the plurality of controls 21 thereon. In the shown embodiment, a control fastener 28 is disposed on a rear surface of the control housing 27, wherein the control fastener 28 is removably securable to a complementary control fastener 30 disposed on an exterior surface of the facemask 12, such that the plurality of controls 21 are readily accessible when the facemask 12 is in use. In the shown embodiment, the control housing 27 is connected to the fan housing 16 via a cable, however, in alternate embodiments, the control housing 27 is in wireless communication with the fan housing 16. In this manner, the fan 18 can be activated upon actuation of the plurality of controls 21.

In the illustrated embodiment, a spacer mask 33 is removably securable to the interior surface 17 of the facemask 12. The spacer mask 33 is contemplated to comprise a semi-rigid material configured to retain the facemask 12 at a desired distance from the user's face, such that the fan 18 is maintained away from the user's mouth. In this manner, the spacer mask 33 creates an operating volume through which air can be circulated by the fan 18. In some embodiments, the spacer mask 33 further comprises a facemask classification sufficient to protect the user from various particulate and contagions, similar to the facemask 12. In the illustrated embodiment, the spacer mask 33 comprises a smaller surface area than the facemask 12 and is generally constrained to covering the mouth and nose of the user, similar to a typical respirator style mask. In some such embodiments, the spacer mask 33 further comprises a fastener 22 on a front side thereof, wherein the fastener 22 is removably securable to the complementary fastener 23 disposed on the interior surface 17 of the facemask 12. Furthermore, an additional complementary fastener 23 is disposed on an interior surface of the spacer mask 33, such that the fan housing 16 can be removably secured within the spacer mask 33 via the fastener 22 thereon. In this manner, the facemask fan system provides a sufficiently large volume between the fan 18 and the user's face to circulate air therethrough.

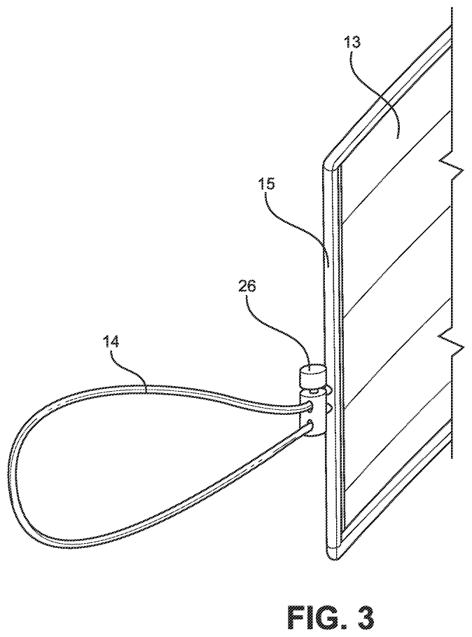

Referring now to FIG. 3, there is shown a close-up view of an ear loop of an embodiment of the facemask fan system. In the shown embodiment, the pair of ear loops 14 are affixed to opposing lateral sides 15 of the flexible cover 13. In the illustrated embodiment, the pair of ear loops 14 are adjustable in diameter, such that the pair of ear loops 14 can be customized for use with a particular individual. In some embodiments, the pair of ear loops 14 comprise an elastic material, such that the pair of ear loops 14 selectively adjust in size as necessary for a user. In the shown embodiment, a drawstring toggle 26 is slidably disposed over each ear loop of the pair of ear loops 14, wherein the drawstring toggle 26 frictionally engages the ear loop upon release of a button thereon. As such, during operation, the user places the ear loop about the user's ear and actuates the button disposed on the drawstring toggle 26 to slide the drawstring toggle 26 along the ear loop to decrease the diameter thereof. Once the ear loop is the desired diameter, the button can be released to frictionally engage the drawstring toggle 26 to the ear loop.

Referring now to FIG. 4, there is shown a schematic view of an embodiment of the facemask fan system. In the shown embodiment, the facemask fan system comprises a fan 18 operably connected to a motor 19, wherein the motor 19 is selectively activated upon actuation of the plurality of controls 21. As previously described, the plurality of controls 21 can be disposed within the fan housing, or alternatively in the separate control housing, such that the plurality of controls 21 can be accessed by the user while the facemask fan system is in use. The power source 20 is operably connected to the motor 19, wherein the power source 20 can comprise a variety of available power sources, such as replaceable batteries, rechargeable batteries, solar cells, or the like. In the illustrated embodiment, a recharging port 32 is further operably connected to the power source 20, wherein the recharging port 32 facilitates the recharging of the power source 20.

In one use, the secures the facemask over their mouth and nose via the pair of ear loops such that the fan housing is secured adjacent to the user's mouth. In embodiments with a removably securable fan housing, the fan housing can first be secured to the interior surface of an existing facemask via the fastener and complementary fasteners. Optionally, the user may further secure the fan housing to an interior of the spacer mask as previously described, at which point the spacer mask can be removably secured to the interior surface of the facemask. In this manner, the fan is maintained at a desired distance from the user's face to provide sufficient volume through which to circulate air. In embodiments having a separate control housing, the control housing is removably securable to an exterior surface of the facemask to provide access to the plurality of controls. Once properly secured, the user can actuate the plurality of controls 21 to activate the motor 19 and rotate the fan 18 to generate circulation beneath the user's facemask.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly, and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A facemask fan system, comprising:
a facemask comprising a flexible cover having a pair of ear loops disposed on opposing lateral sides of the flexible cover;
a fan housing removably securable to an interior surface of the flexible cover;
a fan operably connected to a motor and a power source, wherein the fan, motor, and power source are disposed within the fan housing;
a plurality of controls operably connected to the motor, wherein the plurality of controls selectively toggles the motor between an activated state and a deactivated state.

2. The facemask fan system of claim 1, wherein a rear surface of the fan housing includes a fastener thereon, wherein the fastener is removably securable to a complementary fastener disposed on the interior surface of the flexible cover.

3. The facemask fan system of claim 1, wherein a front surface of the fan housing includes a mesh guard thereacross.

4. The facemask fan system of claim 1, wherein the pair of ear loops are adjustable in diameter.

5. The facemask fan system of claim 4, wherein the pair of ear loops comprise an elastic material.

6. The facemask fan system of claim 4, further comprising a drawstring toggle slidably disposed over each ear loop of the pair of ear loops, wherein the drawstring toggle engages each ear loop at a desired diameter.

7. The facemask fan system of claim 1, further comprising a control housing in operable communication with the fan housing, wherein the plurality of controls is disposed within the control housing.

8. The facemask fan system of claim 7, wherein the control housing further comprises a control fastener disposed on a rear surface thereof, the control fastener removably securable to a complementary fastener disposed on an exterior surface of the flexible cover.

9. The facemask fan system of claim 1, wherein the fan housing further comprises a recharging port operably connected to the power source.

10. The facemask fan system of claim 1, further comprising a spacer mask removably securable to the interior surface of the flexible cover, wherein the fan housing is removably securable to an interior surface of the spacer mask.

11. The facemask fan system of claim 9, wherein the spacer mask comprises a semi-rigid material configured to maintain the facemask at a desired distance from a face of a user.

12. The facemask fan system of claim 1, wherein the flexible cover comprises a plurality of layers, wherein a central layer of the plurality of layers comprises a filter.

13. A facemask fan system, comprising:
a facemask comprising a flexible cover having a pair of ear loops disposed on opposing lateral sides of the flexible cover;
a fan housing integral with the flexible cover;
wherein the fan housing extends through the flexible cover such that an interior portion of the fan housing is disposed on an interior side of the flexible cover, and an exterior portion of the fan housing is disposed on an exterior side of the flexible cover;
a fan operably connected to a motor and a power source, wherein the fan, motor, and power source are disposed within the fan housing;
a plurality of controls operably connected to the motor, wherein the plurality of controls selectively toggles the motor between an activated state and a deactivated state.

14. The facemask fan system of claim 13, wherein a front surface of the fan housing includes a mesh guard thereacross.

15. The facemask fan system of claim 13, wherein the pair of ear loops are adjustable in diameter.

16. The facemask fan system of claim 15, wherein the pair of ear loops comprise an elastic material.

17. The facemask fan system of claim 15, further comprising a drawstring toggle slidably disposed over each ear loop of the pair of ear loops, wherein the drawstring toggle engages each ear loop at a desired diameter.

18. The facemask fan system of claim 13, wherein the fan housing further comprises a recharging port operably connected to the power source.

19. The facemask fan system of claim 13, wherein the flexible cover comprises a plurality of layers, wherein a central layer of the plurality of layers comprises a filter.

20. The facemask fan system of claim 13, wherein an airtight seal is formed between a perimeter of the fan housing and the flexible cover.
